(19) United States
(12) Patent Application Publication
(10) Pub. No.: US 2001/0028943 A1
(43) Pub. Date: Oct. 11, 2001

(54) Adhesive film for adhesive bandage and adhesive bandage using said adhesive film

(76) Inventors: Yasushi Mashiko, Sukagawa-shi (JP); Toshikazu Saito, Sukagawa-shi (JP); Toshiaki Iwamoto, Ohsaka-shi (JP); Yasuro Araida, Ohsaka-shi (JP)

Correspondence Address: Philip S. Johnson, Esq., Johnson & Johnson, One Johnson & Johnson Plaza, New Brunswick, NJ, 08933-7003, US

(21) Appl. No.: 09/759,086

(22) Filed: Jan. 12, 2001

Related U.S. Application Data
(63) Continuation of application No. 09/520,548, filed on Mar. 8, 2000, now abandoned.

(30) Foreign Application Priority Data
Jun. 7, 1993 (JP) 191585/93

(51) Int. Cl. B32B 3/00; B32B 27/14

(52) U.S. Cl. 428/195

(57) ABSTRACT

[CONSTRUCTION]

An adhesive film for adhesive bandage formed by coating an adhesive to a nonwoven fabric comprising 50 to 80% by weight of a styrenic elastomer and 50 to 20% by weight of a polyolefine, and an adhesive bandage using said adhesive film.

[EFFECTS]

The adhesive bandage using the adhesive film for adhesive bandage of the present invention is rich in flexibility and excellent in fitness to a skin, and can prevent physical skin irritation. Because of high moisture permeability, skin respiration is not disturbed and skin irritation caused by being sticky with perspiration is also preventable. Blending of the polyolefine increases strength of the nonwoven fabric itself and imparts strength that does not give any trouble in practical use. Besides, in case of subjecting the surface to a water-repellent finish, it is possible to thoroughly prevent permeation of water into the nonwoven fabric and permeation of water into a pad portion.

### DETAILED DESCRIPTION OF THE PRESENT INVENTION

This invention relates to an adhesive film for adhesive bandage and an adhesive bandage using said adhesive film. More specifically, this invention relates to an adhesive film for adhesive bandage having less skin irritation, said film using as a support a nonwoven fabric comprising 50 to 80% by weight of a styrenic elastomer and 50 to 20% by weight of a polyolefine, and to an adhesive bandage using said adhesive film.

### PRIOR ART AND PROBLEMS THE INVENTION SEEKS TO SOLVE

As an adhesive to a film for adhesive bandage, a product formed by coating an adhesive to a film of vinyl chloride, polyethylene, polypropylene or the like has been hitherto used in many cases. A material such as vinyl chloride, polyethylene, polypropylene or the like is, however, low in moisture permeability; when said material is used in an adhesive bandage and adhered to a skin, it tends to prevent skin respiration and cause skin irritation too.

To prevent same, measure such as formation of air holes in a film, etc. have been taken. However, skin respiration is locally prevented and the air holes cause permeation of water into a pad portion and decrease in strength of a film. Moreover, as the film is less flexible than the skin, it also allows physical irritation to a skin.

### MEANS FOR SOLVING THE PROBLEMS

This invention aims to solve the aforesaid problems by importing sufficient moisture permeability and sufficient flexibility to a film and an adhesive. That is, this invention aims to solve such problems by using an adhesive film for adhesive bandage formed by wholly coating an adhesive, preferably a porous adhesive, to a nonwoven fabric comprising 50 to 80% by weight of a styrenic elastomer and 50 to 20% by weight of a polyolefine.

The styrenic elastomer used in this invention widely includes elastomers formed by copolymerizing styrene as a comonomer with the other comonomer. Examples of the other comonomer can be monomers copolymerizable with styrene, for example diene compounds such as butadiene, isoprene and chloroprene, olefines such as ethylene, propylene, butene and hexene, (meth)acrylic acid, and esters of (meth)acrylic acid and alcohols such as methanol, ethanol, butanol and hexanol. A block copolymer composed of blocks of a hard portion and a soft portion is preferable. Especially preferable is a block copolymer comprising a hard portion of polystyrene and a soft portion of polyisoprene, especially hydrogenated polyisoprene. The hydrogenation reaction can be performed in a nonpolar solvent using a metallic catalyst such as platinum, palladium, nickel, cobalt or the like. Percent hydrogenation is preferably 80% or more, more preferably 90% or more based on the total amount of the double bond. With percent hydrogenation of less than 80%, a nonwoven fabric having sufficient weather resistance may not be obtained.

Such block copolymer is rich in flexibility with low modulus and excellent in compression set, heat resistance, weather resistance and low-temperature properties and the features above are owing to the structural characteristics having the hard and soft portions. Its synthesis method is described in, for example, Japanese Laid-open Patent Appln. (Kokai) Nos. 11059/92 and 136250/92. It is advisable that the amount of such polystyrene block is 10 to 50% by weight based on the total weight of the block copolymer. When it exceeds 50% by weight, stretchability becomes insufficient. When it is less than 10% by weight, tensile strength becomes insufficient.

Examples of the polyolefine of the present invention can be a homopolymer of an olefine such as ethylene, propylene, butene or pentene, a copolymer of two or more of these olefines, etc. Of these, polypropylene is preferable.

The adhesive film for adhesive bandage of the present invention uses a nonwoven fabric comprising a styrenic elastomer and a polyolefine. Namely, a nonwoven fabric made only of the styrenic elastomer is rich in flexibility but poor in mechanical strength and low in breaking strength. When it is, however, blended with a polyolefine, mechanical strength and break strength can greatly be improved. On this occasion, in general, the flexibility gradually decreases with increase in polyolefine content.

The polyolefine content of the adhesive film for adhesive bandage of the present invention is 20 to 50% by weight. When the polyolefine content is less than 20% by weight, sufficient strength may not be obtained. When the polyolefine content exceeds 50% by weight, flexibility becomes insufficient.

The adhesive film for adhesive bandage of the present invention can be improved in moldability, if required, by adding a paraffin oil and so forth. A variety of known additives can be used to improve weather resistance, heat resistance, and so forth, of the material.

The adhesive used in the adhesive film for adhesive bandage of the present invention is not particularly limited if the skin is little irritated and adhesion to the skin is provided; a rubbery adhesive, an acrylic adhesive, and an adhesive of an SIS block copolymer are available. Such adhesive can be coated on the whole adhesive surface of the nonwoven fabric. Preferably, in order to prevent decrease in moisture permeability, a porous adhesive is coated or an adhesive is not wholly coated but pattern-coated.

As a method for making the adhesive porous, a method can be taken which comprises using a highly water-absorbable polymer as a blowing agent, conducting water absorption, then dispersing it in an adhesive solution, coating the dispersion, and evaporating the moisture to make the adhesive porous. However, said method is not critical.

Regarding the pattern coating, the adhesive can be coated on the support by, for example, screen coating method or gravure coating method. However, these coatings are not critical.

As a method for coating an adhesive, there can be employed a method in which the adhesive is directly coated on the nonwoven fabric, a method in which the adhesive is coated on a release paper and then transferred onto the nonwoven fabric, and so forth.

The nonwoven fabric used as the support of the adhesive film for adhesive bandage of the present invention is easy to absorb water, which at times gives rise to a problem that said fabric as such causes water to permeate the inside of the film. Accordingly, it is advisable that the opposite surface to the adhesive coated surface is subjected to a water-repellent finish. This can almost completely prevent the permeation of water into the nonwoven fabric. Examples of the water-repellent are a silicon-type water-repellent, a fluorine-type water-repellent and so forth. However, they are not critical.

The adhesive film for adhesive bandage of the present invention may be formed into the adhesive bandage by any method. Examples of the method are a method in which when the adhesive is not stuck on the opposite surface to the adhesive coated surface, a long film having a suitable width is wound up to form an adhesive bandage, a method in which a sheet of a suitable size is provided, a pad is held on its center, and the adhering surface is covered with a release paper to form an individual pack of the adhesive bandage, and so forth.

This invention is illustrated by the following Examples more specifically.

### EXAMPLES

In Examples, properties were evaluated according to the following methods.

(1) Modulus:

A sample was cut to a width of 25.4 mm (1 inch), and the cut piece was attached to a tensile testing machine at an interval of 50 mm. A load was measured when the test piece was stretched 5%, 10% and 100% at a drawing rate of 100 mm/min.

(2) Tensile Strength at Break and Tensile Elongation at Break:

A sample was cut to a width of 25.4 mm (1 inch), and cut piece was attached to a tensile testing machine at an interval of 50 mm. The test piece was drawn at a drawing rate of 100 mm/min. A load and elongation were measured when the test piece was broken.

(3) Adhesion to glass:

A sample was cut to a width of 25.4 mm (1 inch), and adhered to a glass well washed with acetone. A load was applied thereto by one reciprocation with a roller in which a rubber was wound on an iron core having a weight of 4.5 kg. The glass with the test piece adhered thereto was attached to a tensile testing machine. A drawing rate was set at 300 mm/min, and a load was measured when the test piece was peeled off from the glass surface.

(4) Moisture Permeability:

A sample was adhered to a ring of a moisture permeation cup according to JIS Z 0208, and surely mounted on a guide having a laboratory dish filled with water. Said sample mounted on the guide was placed in a constant-temperature (32° C.)/constant-humidity (30 RH %) device. A weight was measured hourly, which was repeated until a weight difference per hour became stable. Moisture permeability was found from a value of decrease in weight per hour.

(5) Water-repellency:

0.1 ml of water or a 0.75% detergent aqueous solution was dropped on a surface of a sample from a height of 2 cm. A time was measured that lapsed from the time when the solution was dropped to the time when the solution completely permeated the sample.

(6) Evaluation of Skin Irritation:

Skin irritation was evaluated by a patch test under the following evaluation conditions.

a. Specimens

Adhesive bandage using the adhesive film for adhesive bandage in this invention (Examples). Commercial adhesive bandage using a polyvinyl chloride film (Comparative Example).

b. Subject

Grown-up men and women in good health, from 25 to 50 years old—44 persons.

c. Test Method

Two types of specimens were adhered to an inside portion of an upper arm of each person. An adhesive expandable gauze bandage (trade name: Silky Pore) made by Tokyo Eizai Kenkyusho was adhered thereto. An airtight adhesive test for 48 hours was tested. A skin reaction was estimated according to the following standard with the lapse of 1 hour after peeling.

Negative: no reaction is observed at all . . . (−)

False positive: small dim erythema . . . (±)

Positive: clear erythema . . . (+)

Strong positive: erythema, edema and bleb . . . (++)

### Examples 1 to 5 and Comparative Example 1

Using a block copolymer of polystyrene and hydrogenated polyisoprene as a styrenic elastomer and polypropylene as a polyolefine, a nonwoven fabric having a polypropylene content shown in Table 1 was formed by a melt blowing method. An acrylic adhesive having dispersed therein a highly water-absorbable polymer as a blowing agent was coated thereon by a reverse-roll coating method. After dried, it was made porous to form an adhesive film for adhesive bandage. Water-repellent finish was conducted by diluting a water-repellent composed mainly of a fluorine-type resin with water or water:isopropyl alcohol (1:1) in a concentration shown in Table 1, and then coating the diluted water-repellent on the film. The thus obtained adhesive films are designated Example Nos. 1 to 5.

An adhesive film for a commercial adhesive bandage using a polyvinyl chloride film as a support and natural rubber as an adhesive is shown as a Comparative Example in Table 1. The results of measuring properties of the adhesive films for adhesive bandage are shown in Table 1.

TABLE 1

| | | | | | | Com. |
|---|---|---|---|---|---|---|
| Example No. | 1 | 2 | 3 | 4 | 5 | Ex. 1 |
| Support | Styrenic | Styrenic | Styrenic | Styrenic | Styrenic | Vinyl |
| | elast- | elast- | elast- | elast- | elast- | chloride |
| | omer | omer | omer | omer | omer | film |
| Propylene | 30% | 30% | 30% | 40% | 40% | — |
| content | | | | | | |
| Adhesive | Acrylic | Acrylic | Acrylic | Acrylic | Acrylic | Raw |
| | | | | | | rubber |
| Water-repellent | | | | | | |
| finish | | | | | | |
| Solvent | Water | Water: | Water: | Water | Water | — |
| | | IPA | IPA | | IPA | |
| | | (1:1) | (1:1) | | (1:1) | — |
| Concentration | 6% | 2% | 2% + | 6% | 2% | — |
| | | | 2% | | | |
| Test item (unit) | | | | | | |
| Modulus | 0.19 | 0.15 | 0.18 | 0.27 | 0.24 | 0.15 |
| 5% (kg/inch) | | | | | | |
| Modulus | 0.27 | 0.24 | 0.25 | 0.43 | 0.40 | 0.26 |
| 10% (kg/inch) | | | | | | |
| Modulus | 0.64 | 0.61 | 0.60 | 0.92 | 0.95 | 1.82 |
| 100% (kg/inch) | | | | | | |
| Tensile | 1.15 | 1.15 | 1.05 | 1.30 | 1.33 | 3.80 |
| strength | | | | | | |
| at break | | | | | | |
| (kg/inch) | | | | | | |
| Tensile | 491 | 548 | 457 | 421 | 391 | 340 |
| elongation at | | | | | | |
| break (%) | | | | | | |
| Adhesion to | 0.48 | 0.49 | 0.42 | 0.47 | 0.42 | 0.37 |
| glass (kg/inch) | | | | | | |
| Moisture | 3944 | 4066 | 3502 | 3951 | 3905 | 35 |
| permeability | | | | | | |
| (g/cm² · 24 hrs) | | | | | | |
| Water | >3 | >3 | >3 | >3 | >3 | >3 |
| repellency to | | | | | | |
| water (hrs) | | | | | | |
| Water- | >3 | >3 | >3 | >3 | >3 | >3 |
| repellency to | | | | | | |
| detergent water | | | | | | |
| (hrs) | | | | | | |

The results of evaluating skin irritation by a patch test for the adhesive bandages using the adhesive films in Example 1 and the adhesive film in Comparative Example 1 are shown in Table 2.

TABLE 2

Run No.

| Evaluation | 1 | C-1 |
|---|---|---|
| Negative (−) | 43 | 32 |
| False Positive (±) | 1 | 11 |
| Positive (+) | 0 | 1 |
| Strong Positive (++) | 0 | 0 |

From the results in Tables 1 and 2, it follows that since the adhesive film for adhesive bandage of the present invention is rich in flexibility and excellent in fitness to a skin, it has less skin irritation, does not stop skin respiration owing to the excellent air permeability and can prevent a trouble caused by being sticky with perspiration and so forth.

### Examples 6 and 7

Effects provided by the water-repellent finish were observed on the adhesive film for adhesive bandage having the same composition as in Example 1. A water-repellent composed mainly of a fluorine resin was used. The results are shown in Table 3.

TABLE 3

| Example No. | 6 | 7 |
|---|---|---|
| Conditions for | | |
| water-repellent finish | | |
| Solvent | — | Water |
| Amount | — | 10 wt. % |
| Test item (unit) | | |
| Moisture permeability | 1197 | 2140 |
| (g/m³ · 24 hrs) | | |
| Water-repellency to water | | |
| Water-repellency to detergent | >3 hrs | >3 hrs |
| Aqueous solution | 10-20 sec. | >3 hrs |

Table 3 reveals that moisture permeability little changes by the water-repellent finish. Moreover, regarding water repellency to water, since the styrenic elastomer is hydrophobic, a difference due to the water-repellent finish is not observed. While, regarding water repellency to detergent aqueous solution, a difference due to the water-repellent finish is clearly observed.

[Effects of the Invention]

The adhesive bandage using the adhesive film for adhesive bandage of the present invention is, owing to structural characteristics of the styrenic elastomer, rich in flexibility and excellent in fitness to a skin, and can prevent physical skin irritation. Moreover, because of high moisture permeability, skin respiration is not disturbed and skin irritation caused by being sticky with perspiration is also preventable. Blending of the polyolefine increases strength of the nonwoven fabric itself and imparts strength that does not give any trouble in practical use. Besides, in case of subjecting the surface to a water-repellent finish, it is possible to thoroughly prevent permeation of water into the nonwoven fabric and permeation of water into a pad portion.

We claim:

1. An adhesive film for adhesive bandage formed by coating an adhesive to a nonwoven fabric comprising 50 to 80% by weight of a styrenic elastomer and 50 to 20% by weight of a polyolefine.

2. The adhesive film for adhesive bandage of claim 1 wherein the polyolefine is polypropylene.

3. The adhesive film for adhesive bandage of claim 1 wherein the stryrenic elastomer is a block copolymer composed of a polystyrene block and a polyisoprene block.

4. The adhesive film for adhesive bandage of claim 3 wherein the polyisoprene block contains hydrogenated polyisoprene.

5. The adhesive film for adhesive bandage of claim 1 wherein the styrenic elastomer is an A-B-A type triblock copolymer.

6. The adhesive film for adhesive bandage of claim 4 wherein the hydrogenation percentage of the polyisoprene block is 80% or more.

7. The adhesive film for adhesive bandage of claim 1 wherein the adhesive is a rubbery polymer, an acrylic polymer or a SIS type block copolymer.

8. The adhesive film for adhesive bandage of claim 1 wherein the adhesive is porous.

9. The adhesive film for adhesive bandage of claim 1 wherein the adhesive is pattern-coated.

10. The adhesive film for adhesive bandage of claim 1 wherein the opposite surface to the adhesive coated surface is subjected to a water-repellent finish.

11. An adhesive bandage using the adhesive film of claim 1.
